(19) United States
(12) Patent Application Publication
(10) Pub. No.: US 2026/0195587 A1
(43) Pub. Date: Jul. 9, 2026

(54) MOTION FEATURE MATCHING FOR TEXT-TO-VIDEO DIFFUSION MODELS

(71) Applicant: NVIDIA Corporation, Santa Clara, CA (US)

(72) Inventors: Fu-En Yang, Taipei City (TW); Yu-Chiang Wang, Neihu District (TW); Chi-Pin Huang, Neihu District (TW); Yen-Siang Wu, Neihu District (TW)

(21) Appl. No.: 19/337,773

(22) Filed: Sep. 23, 2025

Related U.S. Application Data
(60) Provisional application No. 63/742,345, filed on Jan. 6, 2025.

(51) Int. Cl. G06N 3/08; G06N 3/0475; G06T 7/246

(52) U.S. Cl. CPC G06N 3/08; G06N 3/0475; G06T 7/248; G06T 7/251; G06T 2207/20081; G06T 2207/20084

(57) ABSTRACT

Text-to-video (T2V) diffusion models have shown promising capabilities in synthesizing realistic videos from input text prompts. The input text description alone may provide limited control over the precise motion trajectories of objects and backgrounds. Disclosed are processes that can use a reference video as motion guidance. A motion customization framework that fine-tunes a pretrained T2V diffusion model in motion feature spaces can be used. Instead of using pixel-level objectives, the disclosed processes compare high-level, spatio-temporal motion features for diffusion model fine-tuning to ensure precise motion learning. These features can be computed by utilizing a pretrained T2V diffusion model as a feature extractor, which can contain prior knowledge about video motion. The framework can extend the motion features to perform the task of motion retrieval.

### CROSS-REFERENCE

This application claims the benefit of U.S. Provisional Application Ser. No. 63/742,345, filed by Fu-En Yang, et al., on Jan. 6, 2025, entitled “MOTION CUSTOMIZATION OF TEXT-TO-VIDEO DIFFUSION MODELS VIA MOTION FEATURE MATCHING,” commonly assigned with this application and incorporated herein by reference in its entirety.

### TECHNICAL FIELD

This application is directed, in general, to machine learning language models and, more specifically, to text-to-video diffusion models.

### BACKGROUND

Text-to-video models are machine learning (ML) models that generate videos based on an input text description. A text-to-video (T2V) diffusion model is an example of an ML model that uses a text description and generates a video using a diffusion process. A T2V diffusion model has a neural network architecture that is configured to generate data similar to tuning data that is used for training. The training data can include reference motion videos that are provided to the T2V diffusion model for motion learning. Customized T2V generation aims to produce high-quality videos that incorporate user-specified subject identities or motion patterns. Existing methods mainly focus on personalizing a single concept, either subject identity or motion pattern, limiting their effectiveness for multiple subjects with the desired motion patterns.

### SUMMARY

In one aspect, a text-to-video (T2V) system is disclosed. In one embodiment, the T2V system includes (1) a receiver configured to receive a reference video and a pretrained T2V diffusion model, wherein the reference video includes target motion features, (2) a motion feature extractor configured to extract the target motion features from the reference video and diffusion motion features from the pretrained T2V diffusion model using a neural network model, and (3) a motion feature matcher configured to use a feature matching objective and to generate an adjusted pretrained T2V diffusion model from the pretrained T2V diffusion model by applying adjusted diffusion motion features, and wherein the feature matching objective generates the adjusted diffusion motion features from the diffusion motion features by minimizing an L2 distance between the diffusion motion features and the target motion features.

In a second aspect, a system is disclosed. In one embodiment, the system includes (1) a receiver configured to receive input parameters, wherein the input parameters include at least a pretrained text-to-video (T2V) diffusion model, at least one target motion video, and operation parameters, and (2) one or more processors, configured to execute code to generate an adjusted pretrained T2V diffusion model from a received pretrained T2V diffusion model by extracting target motion features from the at least one target motion video, extracting diffusion motion features from the received pretrained T2V diffusion model, and using a feature matching objective to adjust the received pretrained T2V diffusion model by minimizing an L2 distance between the diffusion motion features and the target motion features.

In a third aspect, a method is disclosed. In one embodiment, the method includes (1) receiving a reference video and a pretrained text-to-video (T2V) diffusion model, wherein the reference video includes target motion features, (2) extracting the target motion features from the reference video using a neural network model, (3) extracting diffusion motion features from the pretrained T2V diffusion model using the neural network model, (4) matching motion of the diffusion motion features to the target motion features using a feature matching objective, wherein the feature matching objective utilizes a minimization of an L2 distance between the diffusion motion features and the target motion features, and (5) generating an adjusted pretrained T2V diffusion model by applying an output of the feature matching objective to the pretrained T2V diffusion model.

In a fourth aspect, a non-transitory computer-readable medium having a series of operating instructions stored thereon that directs a data processing apparatus when executed thereby to perform operations is disclosed. In one embodiment, the operations include (1) receiving a reference video and a pretrained text-to-video (T2V) diffusion model, wherein the reference video includes target motion features, (2) extracting the target motion features from the reference video using a neural network model, (3) extracting diffusion motion features from the pretrained T2V diffusion model using the neural network model, (4) matching motion of the diffusion motion features to the target motion features using a feature matching objective, wherein the feature matching objective utilizes a minimization of an L2 distance between the diffusion motion features and the target motion features, and (5) generating an adjusted pretrained T2V diffusion model by applying an output of the feature matching objective to the pretrained T2V diffusion model.

### BRIEF DESCRIPTION

Reference is now made to the following descriptions taken in conjunction with the accompanying drawings, in which:

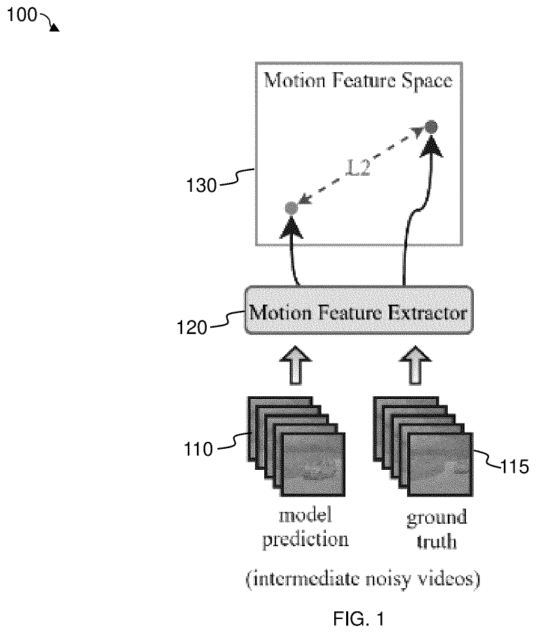

FIG. 1 is an illustration of a diagram of an example motion matcher process;

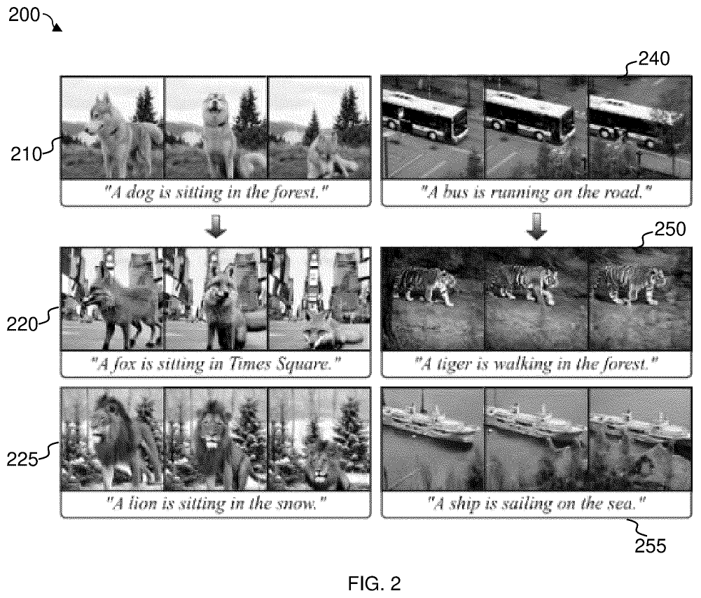

FIG. 2 is an illustration of a diagram of example implementations of an adjusted pretrained T2V diffusion model;

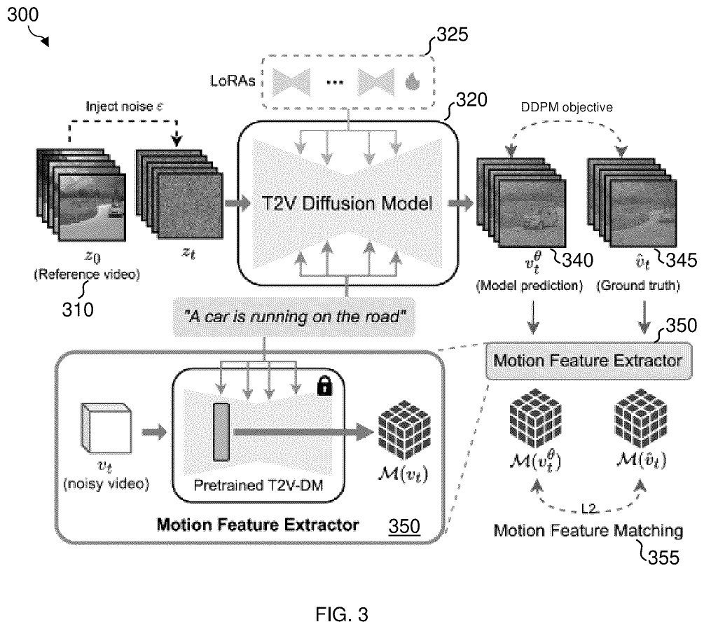

FIG. 3 is an illustration of a function diagram of an example training function;

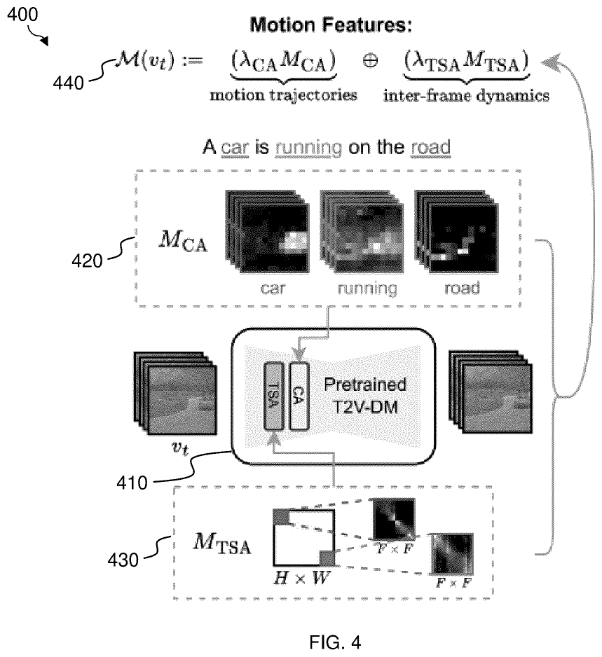

FIG. 4 is an illustration of a diagram of an example motion feature extraction;

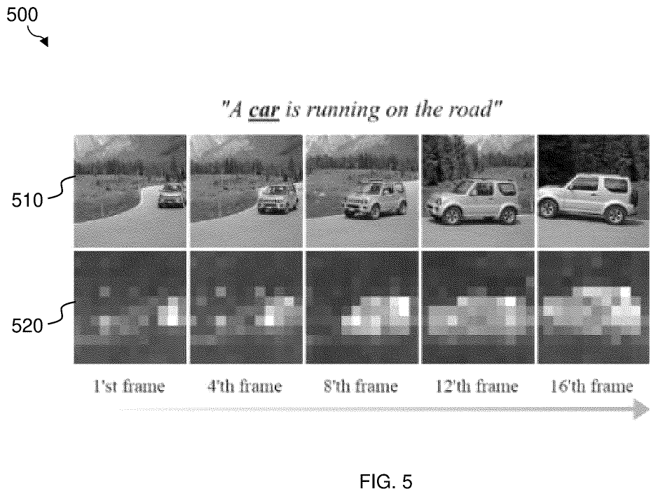

FIG. 5 is an illustration of a diagram of an example cross-attention map visualization;

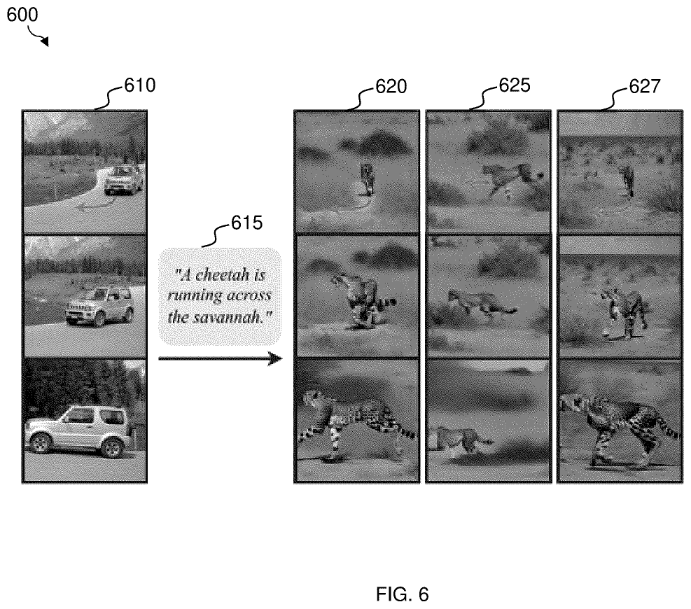

FIG. 6 is an illustration of a diagram of an example ablation result;

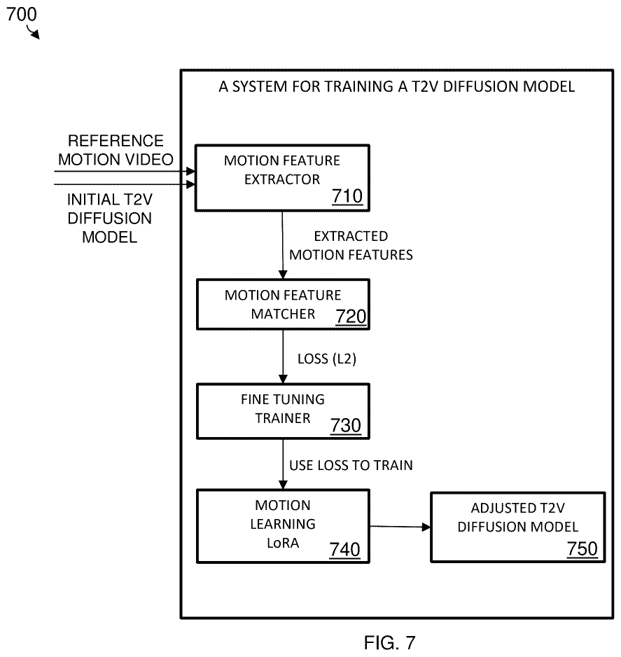

FIG. 7 is an illustration of a block diagram of an example system for training a T2V diffusion model;

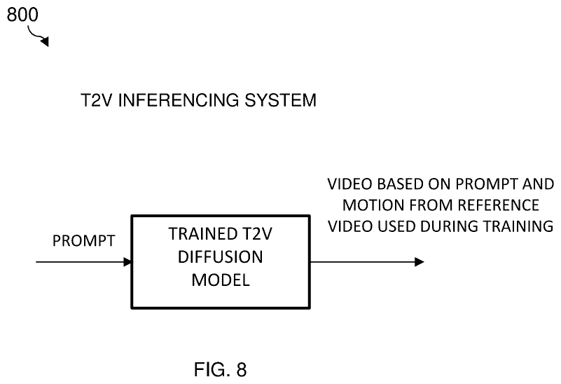

FIG. 8 is an illustration of a block diagram of an example video generation system;

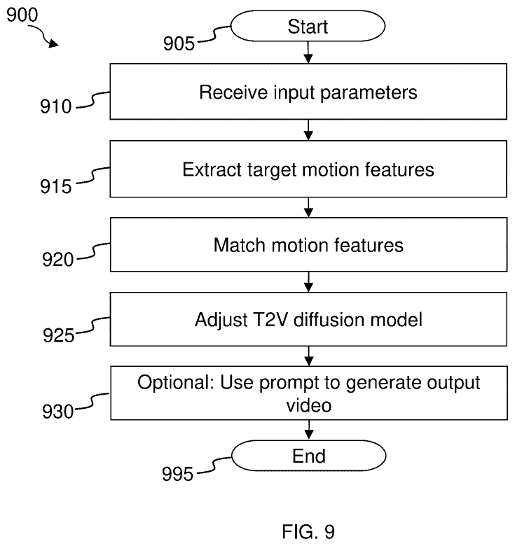

FIG. 9 is an illustration of a flow diagram of an example method for adjusting the training for a pretrained T2V diffusion model;

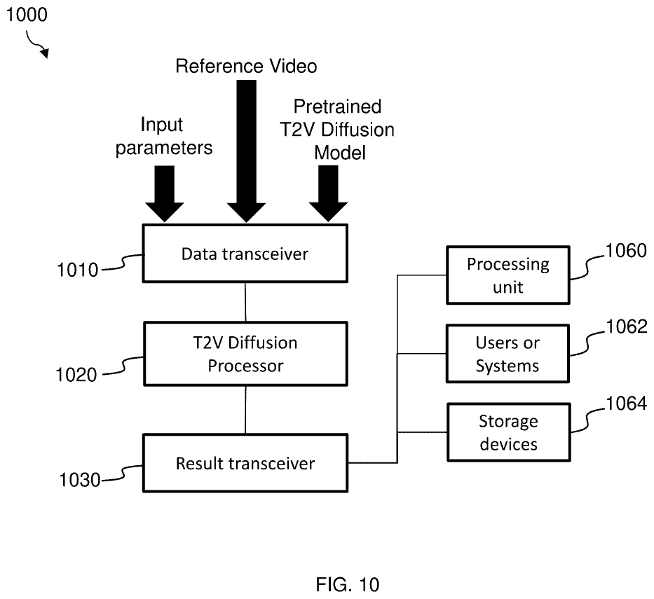

FIG. 10 is an illustration of a block diagram of an example T2V system; and

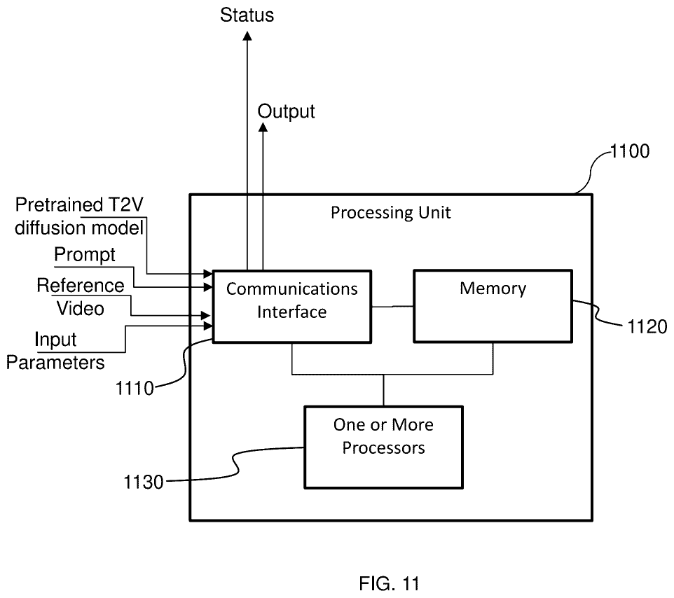

FIG. 11 is an illustration of a block diagram of an example of a T2V controller according to the principles of the disclosure.

### DETAILED DESCRIPTION

To control the rhythm of a movie scene, movie directors would carefully arrange the precise movements and positioning of the actors and the camera for each shot. Similarly, to control the pacing and flow of AI-generated videos, users should have control over the motion of video generation models. To this end, motion customization has been proposed to control text-to-video (T2V) diffusion models with the motion of a reference video. With the assistance of this reference video, users can specify the desired motion trajectories for objects and backgrounds in the output videos.

Analyzing video motion can require the ability to identify (1) object positions and (2) the patterns of positional changes across frames, e.g., a zoom parameter, a rotation parameter, an orientation parameter, a movement parameter, a displacement parameter, or various combinations thereof. Object positions and patterns of positional change are high-level concepts. The high-level nature of motion can be evident in optical flow estimation, which is an area of research in video motion analysis. Early efforts in this domain primarily relies on rule-based algorithms that use handcrafted rules to model motion. Such methods often struggle to handle complex motion patterns, such as large displacements, non-rigid movements, and motion in low-texture regions, due to their inability to capture high-level semantics of video.

With advances in machine learning, recent studies have shifted towards data-driven methods that learn motion patterns from large datasets. These approaches have improved motion estimation by leveraging deep neural networks to understand motion at the feature level, highlighting the importance of a high-level understanding of motion.

In the context of motion customization, given that motion is inherently a high-level concept, pixel-level objectives, such as frame-difference matching, can be insufficient for accurately capturing motion information. These objectives can fail to capture complex motion, as observed in early research on optical flow estimation, and can unintentionally capture irrelevant details, such as visual appearance and video content.

This disclosure presents processes that can extract motion information with the assistance of a neural network model, e.g., a deep neural network model, a machine learning model, an artificial intelligence model, or other types of neural network models. By leveraging a large pretrained model, the disclosed processes understand the high-level semantics of video and captures key information such as object positions and motion patterns. As the motion features are extracted from a deep neural network, they are better suited to understand high-level, abstract concepts like motion compared to previous methods.

The disclosed processes can use the pretrained T2V diffusion model itself as the neural network model for feature extractor M. Using the T2V diffusion model as the neural network model can be beneficial because diffusion models can be trained to process noisy latent videos directly, avoiding training-inference gaps, and diffusion models can contain learned representations that capture high-level motion semantics. When the noisy latent video vₜ is fed through the pretrained T2V diffusion model, the network can compute intermediate attention maps during its forward pass. The disclosed processes can extract two specific attention mechanisms from the model's intermediate layers, such as shown in FIG. 4. Cross-Attention maps, such as shown in Equation 5, can be used for the network to compute correlations between spatial-temporal activations and word embeddings, producing M_{CA} that encodes camera framing and object positioning. Temporal self-attention (TSA) maps, such as shown in Equation 6, can be used for the network to compute frame-to-frame correlations at each spatial location, producing M_{TSA} that captures object movements and dynamics. The neural network model can transform raw noisy videos into semantic motion features through its layers trained on massive video datasets. This enables capturing complex motions (rapid movements, non-rigid deformations, low-texture regions) that pixel-level methods may fail to represent.

Given a reference video containing the target motion, motion customization aims to adjust a pretrained T2V diffusion model, so the output videos sampled from the adjusted model follow the target motion. Motion is a high-level, abstract concept involving complex spatio-temporal relationships. Some conventional solutions use fine-tuning of diffusion models using objectives that compare the frame differences of the output video with the frame differences of the reference video, for example, using a motion distillation objective that learns the residual frames of the reference video. Some of these solutions can use an appearance-debiased objective that learns the differences between an anchor frame and other frames.

Frame differences may not accurately represent motion. For example, two videos with the same motion, such as a red car and a blue car driving leftward, can yield different frame differences because the pixel changes occur in different color channels in each video. Moreover, frame differences cannot capture the underlying patterns of complex motion, such as rapid movements or movements in low-texture regions. In these cases, the strategy of matching frame differences can fail to reproduce the target motion and end up learning irrelevant content from the reference video.

The disclosed processes can use a motion matcher system to overcome these noted deficiencies by implementing a fine-tuning framework for motion customization via motion feature matching. The disclosed processes can employ a feature matching objective (i.e., perceptual loss), as it compares high-level motion features extracted from pretrained models, rather than directly comparing pixel values or frame differences. Since these motion features are extracted from a sophisticated pretrained model, they can accurately capture complex motion patterns by understanding the spatio-temporal relationships in a video. This effectively resolves the problem encountered in previous work, where frame differences fail to capture complex motion patterns.

At each fine-tuning step, the disclosed processes use a feature extractor to capture the high-level motion features of the output noisy video and the ground truth noisy video. The feature matching objective then minimizes the L2 distance (e.g., Euclidean distance, mean square error distance) between their motion features, thereby generating adjusted diffusion motion features. Considering that diffusion models are designed to output videos at certain noise levels, the feature extractor can possess the ability to encode noisy videos. To obtain such a feature extractor, the following can be used: (1) pretrained diffusion models' ability in extracting features from noisy inputs and (2) the spatio-temporal parameters encoded in attention maps. Typically, cross-attention (CA) maps in pretrained diffusion models contain information about coarse-grained motion trajectories, while TSA maps contain fine-grained motion dynamics. Therefore, CA and TSA maps can be used to represent motion features.

The disclosed processes describe a feature-level fine-tuning framework for motion customization. Instead of using a pixel-level denoising diffusion probabilistic model (DDPM) objective, the disclosed processes can utilize high-level motion features for training low-rank adaptations (LoRAs), capturing the desired motion information. Utilizing pretrained diffusion models to extract motion features, spatial-temporal motion trajectories and inter-frame motion dynamics can be extracted from different attention mechanisms within the model. The disclosed processes can perform motion retrieval tasks.

Turning now to more specific implementation guidelines, given a reference video z₀ (e.g., a target motion video) containing the target motion and a text prompt y associated with the video, motion customization aims to adjust a pretrained T2V diffusion model ε_{θ}, so the output videos sampled from the adjusted model follow the target motion. T2V diffusion models can be probabilistic generative models that learn to synthesize videos by gradually denoising a sequence of randomly sampled Gaussian noise frames (in latent space), guided by a textual condition y. To model temporal information, T2V diffusion models typically inflate a pretrained text-to-image (T2I) diffusion model by inserting temporal layers. These temporal layers can be made up of feedforward networks and temporal self-attentions, where TSA maps apply self-attention along the frame axis. Training T2V diffusion models ε_{θ} are trained by minimizing a weighted noise-prediction objective, such as shown in Equation 1.
Equation 1: Example weighted noise-prediction objective

$${𝔼}_{{z}_{0} , t , ϵ} [ {w}_{t} {‖ ϵ - {ϵ}_{θ} ( {z}_{t} , t , y ) ‖}^{2} ]$$

where

$${z}_{t} = \sqrt{{\overline{α}}_{t}} {z}_{0} + \sqrt{1 - {\overline{α}}_{t}} ϵ$$

is the noisy video at timestep t,
ϵ~N(0, I) is Gaussian noise, and
wₜ is a time-dependent weighting term.

This noise-prediction objective (i.e., Equation 1) is equivalent to predicting the previous noised video through a different parametrization, as shown in Equation 2.
Equation 2: Example weighted noise-prediction objective using different parameterization than Equation 1

$${𝔼}_{{z}_{0} , t , ϵ} [ {w}_{t}^{′} {‖ {v}_{t} ( {z}_{t} , ϵ ) - {v}_{t} ( {z}_{t} , {ϵ}_{θ} ( {z}_{t} , t , y ) ) ‖}^{2} ]$$

where vₜ(zₜ, ϵ) is equal to

$$\frac{1}{\sqrt{{α}_{t}}} {z}_{t} + ( - \frac{\sqrt{1 - {\overline{α}}_{t}}}{\sqrt{{α}_{t}}} + \sqrt{1 - {\overline{α}}_{t - 1}} )$$

ϵ and is the estimated noised video at timestep t−1 computed from zₜ and ϵ, and

$${w}_{t}^{′}$$

is the time-dependent weight after reparametrization.

For simplicity, we will use \hat{v}ₜ to denote the ground truth noised video vₜ(zₜ, ϵ), and use

$${v}_{t}^{θ}$$

to denote the predicted noised video vₜ(zₜ, ϵ_{θ}(zₜ, t, y)). The objective can therefore be rewritten as shown in Equation 3.
Equation 3: Example simplified noise prediction objective function

$${𝔼}_{{z}_{0} , t , ϵ} [ {w}_{t}^{′} {‖ {\hat{v}}_{t} - {v}_{t}^{θ} ‖}^{2} ]$$

where

$${w}_{t}^{′}$$

is the time-dependent weight.

Since motion information can be too complex to be interpreted at the pixel level, directly applying the pixel-level DDPM objective for motion customization would not be sufficient to precisely capture the motion in reference videos. To avoid possible extraction of irrelevant information, such as content, visual appearance, and styles, a proper learning scheme needs to be presented for motion customization.

A feature matching objective, for motion, can be used where a deep feature extractor M is introduced to capture high-level motion information. Instead of directly aligning the predicted noisy video

$${v}_{t}^{θ}$$

with the ground truth noisy video \hat{v}ₜ in the pixel space, their motion features can be extracted and aligned in the motion feature space, as shown in Equation 4.
Equation 4: Example extraction of motion features and alignment in the motion feature space

$${ℒ}_{mot} ( θ ) = {𝔼}_{{z}_{0} , t , ϵ} [ {w}_{t}^{′} {‖ M ( {\hat{v}}_{t} ) - M ( {v}_{t}^{θ} ) ‖}^{2} ]$$

where M is a motion feature extractor for noisy videos, and

$${w}_{t}^{′}$$

is the time-dependent weight.

Commonly used visual feature extractors are trained on images that cannot be directly applied to describing temporal or motion features of video data. Pretrained diffusion models can be capable of capturing rich semantic and structural information from noisy data. Since such models are trained on noisy inputs, using them as feature extractors for noisy videos can eliminate the potential training-inference gap. In light of the above observations, a pretrained T2V diffusion model can be used as the motion feature extractor M to capture complex spatial-temporal motion patterns.

Cross-attention maps in diffusion models can serve as strong descriptors of object positions. The disclosed processes can extract CA maps within the T2V diffusion model, which can be viewed as spatial-temporal motion trajectories across video frames. In T2V diffusion models, the CA maps can be softmax-normalized matrices M_{CA}∈[0, 1]^{F×H×W×|c|}, calculated by first reshaping the 3-dimensional (3D) intermediate activations Φϵ [symbol] into the shape (H×W×F)×D, where the activation parameters are F (frames), H (height), W (width), and D (depth). Cross-attention can then be performed between these activations (P and word embeddings τ(y) as shown in Equation 5.
Equation 5: Example activations and word embeddings

$${M}_{CA} = Soft max ( \frac{Q ( Φ ) {K ( τ ( y ) )}^{T}}{\sqrt{D}} )$$

where τ denotes the text encoder used in the T2V diffusion model, and
y is the text prompt given by the user.

In M_{CA}, each element (M_{CA})_{i,j,k,l} can represent the correlation between the l'th word in the text prompt and the spatial-temporal coordinate (i, j, k). M_{CA} can be applied to capture the coarse-grained trajectories of object movement. Although coarse-grained motion information can be extracted from CA maps, in some aspects, fine-grained motion dynamics of video can be used for a comprehensive understanding of video motion.

In addition to extracting spatial-temporal motion trajectories, the temporal motion dynamics encoded within T2V diffusion models can be used. Such temporal dynamics aim to capture motion details that cannot be captured by motion trajectories alone, such as object rotation, deformable motion, and motion that does not involve positional changes. To capture inter-frame motion dynamics from noisy videos, TSA maps can be extracted from T2V diffusion models and incorporated into the diffusion motion features. To compute TSA maps M_{TSA}, T2V diffusion models can reshape the 3D intermediate activations Φ∈ [symbol] into the shape (H×W)×F×D and perform self-attention along the frame axis, independently for each pixel, as shown in Equation 6.
Equation 6: Example self-attention algorithm

$${( {M}_{TSA} )}_{i , j} = Soft max ( \frac{Q ( {Φ}_{i , j} ) {K ( {Φ}_{i , j} )}^{T}}{\sqrt{D}} )$$

where i and j are the spatial coordinates of a pixel.

Each element (M_{TSA})_{i,j,k,l} of the resulting TSA map M_{TSA}∈[0, 1]^{H×W×F×F} indicates the correlation between the k'th frame and the l'th frame at spatial coordinate (i, j). M_{TSA} models the frame-to-frame correlation at each position, representing the fine-grained motion dynamics of video.

With the CA maps describing coarse-grained motion trajectories and the TSA maps reflecting fine-grained motion dynamics, they can be combined to form the motion features, as shown in Equation 7.
Equation 7: Example forming the motion features

$$( {λ}_{CA} {M}_{CA} ) ⊕ ( {λ}_{TSA} {M}_{TSA} )$$

where λ_{CA} and λ_{TSA} are weights that control the contributions of each component.

Once the motion features are extracted, the pretrained T2V diffusion model can be fine-tuned with the motion feature matching objective, such as shown in Equation 4, to capture motion information from the reference video z₀. To preserve the prior knowledge in the pretrained model while customizing it for the target motion, LoRAs can be injected into the spatial and temporal layers of the pretrained T2V diffusion model, as shown in Equation 8.
Equation 8: Example injection of low-rank adaptations

$$\begin{matrix}arg min \\ Δθ\end{matrix} {ℒ}_{mot} ( θ + Δθ )$$

where Δθ is a low-rank parameter increment.

Through these motion-aware LoRAs, the disclosed processes can be capable of synthesizing videos that are guided by textual descriptions while adhering to the motion patterns captured from the provided reference videos. Specifically, the processes can generate N 2-dimensional (2D) point trajectories for the reference video, denoted as \hat{T}₀, \hat{T}₁, . . . , \hat{T}_{N}∈ [symbol] , and N 2D point trajectories for the generated video, denoted as T₀, T₁, . . . , T_{N}∈ [symbol] . In some aspects, to measure the similarity between these two sets of F×2 dimensional vectors, the Chamfer distance (e.g., Chamfer algorithm) can be used, which is a metric used to assess the similarity between two sets of points in point cloud generation. Consequently, motion discrepancy can be defined as shown in Equation 9.
Equation 9: Example motion discrepancy

$$C ( \frac{1}{N} {\sum }_{i} \begin{matrix}min \\ j\end{matrix} {‖ {T}_{i} - {\hat{T}}_{j} ‖}^{2} + \frac{1}{N} {\sum }_{j} \begin{matrix}min \\ j\end{matrix} {‖ {T}_{i} - {\hat{T}}_{j} ‖}^{2} )$$

where

$$C = \frac{1}{2 {FH}^{2} {W}^{2}}$$

is a normalization constant.

Through experimentation, the disclosed processes capture motion information from noisy videos, for example, having an encoder configured to encode noisy videos. From a dataset, object video clips with diverse motion trajectories and camera movements can be generated. These object video clips can be clipped for the experiments, for example, to 16 frames, where other frame counts can be used in other implementations. The motion features can be obtained by adding noise to each video z and feeding them into the motion feature extractor, as shown in Equation 10.
Equation 10: Example motion feature extractor

$$M ( \sqrt{{\overline{α}}_{t}} z + \sqrt{1 - {\overline{α}}_{t}} ϵ )$$

where M denotes our motion feature extractor, and
time step t is set to a specified number, for example, 500.

After getting the motion features of the videos, a query video is selected. The query video is used to retrieve the most similar video from the dataset based on the motion features. The video with the most similar motion features shares the same motion despite having different appearances. In contrast, the video that is most similar in pixel space has a nearly identical appearance while opposite motion, while the video with the most similar residual frames contains unrelated motion. The result verifies that the motion feature extractor is capturing motion information, rather than irrelevant appearance details.

Removing TSA maps M_{TSA} from the motion features causes the model to capture coarse-grained motion trajectories and fail to replicate the target motion precisely. Removing CA maps M_{CA} from the motion features can have minimal impact on motion fidelity while resulting in reduced motion quality and realism in the generated video. This can be attributed to the lack of global comprehension of motion, which is important when transferring motion to a distinct object.

The disclosed processes modify the DDPM objective into the form of feature matching, aiming to precisely capture the motion component of a video with a sophisticated feature extractor. It utilizes a pretrained T2V diffusion model as the feature extractor and identifies valuable motion information from two attention mechanisms within it, which represent spatio-temporal motion trajectories and inter-frame motion dynamics.

In an example implementation, to fine-tune the diffusion model, LoRAs can be added to self-attention and feed-forward layers, and an initial rank can be set to 32 (or other rank values can be used). Since motion is mainly determined in early stages, the time-dependent weights w′ₜ in the objective function can be set to 1 for the first 500 steps and 0 for the last 500 steps (where other values can be used in other implementations). The model can be fine-tuned for a specified number of time steps, for example, for 400 steps, which takes approximately 15 minutes on the test environment that includes an NVIDIA GeForce RTX 4090 from NVIDIA Corporation of Santa Clara, California.

For feature extraction, CA maps and TSA maps can be extracted from a block at a 12×12 resolution (where other block resolutions can be used in other implementations). The M_{CA} and M_{T}SA represent the average of extracted attention maps across heads and layers, which can be omitted in the equations for conciseness. For initial noise, denoising diffusion implicit model (DDIM) inversion can be used to obtain the initial noise z_{T}. The initial noise z_{T} can be computed as shown in Equation 11.
Equation 11: Example initial noise computation

$${z}_{T} = \sqrt{β} {ϵ}_{inv} + \sqrt{1 - β} ϵ$$

where ϵ~N(0, I) is Gaussian noise, and
ϵᵢₙᵥ represents the inverted noise of the reference video, derived via DDIM inversion.

The square root terms in the equation ensure that the variance of z_{T} remains consistent across various values of β. In quantitative experiments and human user studies, the value can be set to β=0.3. In other experiments, β can vary between the range of 0.1 to 0.3.

Turning now to the figures, FIG. 1 is an illustration of a diagram of an example motion matcher process 100. Motion matcher process 100 has an initial pretrained T2V diffusion model 110 and a reference video 115. The motion features can be extracted from initial pretrained T2V diffusion model 110 and a reference video 115 using a motion feature extractor function 120. Once the features have been extracted, the features can be used to determine the adjustments needed to initial pretrained T2V diffusion model 110 to better align its LoRAs to the features of the reference video, as shown in motion feature space 130, to generate an adjusted pretrained T2V diffusion model. The label L2 in motion feature space 130 represents the L2 distance (e.g., the Euclidean distance or the mean square loss distance) between the two points.

FIG. 2 is an illustration of a diagram of example implementations 200 of adjusted pretrained T2V diffusion models. Instead of directly aligning the predicted noisy video

$${v}_{t}^{θ}$$

with the ground truth noisy video \hat{v}ₜ in the pixel space, motion features are extracted and aligned in the motion feature space, as shown in Equation 4.

Implementations 200 demonstrate a reference video 210 of a dog sitting in the forest. Reference video 210 is applied to a pretrained T2V diffusion model. The pretrained T2V diffusion model is then prompted with a text prompt of, “A fox is sitting in Times Square” resulting in output 220, and prompted with a text prompt of, “A lion in sitting in the snow” resulting in output 225. This shows that the movements of an animal can be abstracted and applied to a variety of animals.

Implementations 200 demonstrate a reference video 240 of a bus running on the road. Reference video 240 is applied to a pretrained T2V diffusion model. The pretrained T2V diffusion model is then prompted with a text prompt of, “A tiger is walking in the forest” resulting in output 250, and prompted with a text prompt of, “A ship is sailing on the sea” resulting in output 255. This shows that the movements of an object can be abstracted and applied to a variety of animals and objects, even if the motion is not the same, e.g., a bus rolls, a tiger walks, and a ship glides.

FIG. 3 is an illustration of a function diagram of an example training system 300 that can be implemented on one or more processors. Training system 300 can use feature-level information for motion learning. Unlike conventional DDPM solutions, the disclosed processes can align a predicted noisy video

$${v}_{t}^{θ}$$

340 with a ground truth noisy video \hat{v}ₜ 345 in the motion feature space. This alignment can occur after the motion features are extracted in a motion feature extractor 350. The alignment of the motions can occur using a motion feature matching function 355. Reference video 310 (e.g., a target motion video) can be used to generate the target motion features that are used as training inputs to pretrained T2V diffusion model 320. A set of LoRAs 325 of pretrained T2V diffusion model 320 can be adjusted to reflect the target motion features extracted from the reference video 310. An example of motion feature extractor 350 is provided in FIG. 4.

FIG. 4 is an illustration of a diagram of an example motion feature extractor 400. To describe the motion features of noisy videos, CA maps and TSA maps from a pretrained T2V diffusion model 410 can be used. M_{CA} (cross-attention map motions) are applied to capture the coarse-grained trajectories of object movement, such as shown in Equation 5. M_{TSA} (temporal self-attentions map motions) are applied to capture the fine-grained motion dynamics of the object, such as shown in Equation 6.

The various attention maps can be combined to produce the final motion features. Pretrained T2V diffusion model 410 can include a set of CA maps 420 capturing the motion trajectory parameters. Pretrained T2V diffusion model 410 can include a set of TSA maps 430 capturing the inter-frame dynamics. A set of motion features can be identified by combining the output of set of CA maps 420 and set of TSA maps 430, such as using equation 440 or as shown in Equation 7.

FIG. 5 is an illustration of a diagram of an example CA map visualization 500. CA map visualization 500 (e.g., M_{CA}) can be computed between the activations in a pretrained T2V diffusion model and an input text prompt y. Given a reference video and its caption, the CA map can be obtained by adding noise to the video and using the pretrained T2V diffusion model as a feature extractor. In this example, the extracted set of CA maps 520 reveals the position and trajectory of the word “car” in the prompt y, as shown in a set of video frames 510.

FIG. 6 is an illustration of a diagram of an example ablation result 600. Ablation result 600 has a reference video 610, a text prompt 615, a result 620 that uses sets of attention maps, a result 625 that uses the M_{CA} attention map motion features and not the M_{T}SA attention map motion features, and a result 627 that uses the M_{T}SA attention map motion features and no M_{CA} attention map motion features.

Removing temporal self-attention maps M_{T}SA from the motion features causes the model to capture coarse-grained motion trajectories and fail to replicate the target motion precisely. Removing cross-attention maps M_{CA} from the motion features has minimal impact on motion fidelity while resulting in reduced motion quality and realism in the generated video. This can be attributed to the lack of global comprehension of motion, which is important when transferring motion to a distinct object.

FIG. 7 is an illustration of a block diagram of an example system 700 for training a T2V diffusion model. System 700 can receive a reference video and an initial T2V diffusion model. Target motion features can be extracted from the reference video (e.g., a target motion video) using, for example, a motion feature extractor 710. A motion feature matcher 720 can implement a feature matching objective. The first step can be to match or align motion features extracted from the reference video and motion features extracted from a pretrained T2V diffusion model. Motion feature matcher can generate an L2 loss between the two sets of motion features.

A fine-tuning trainer 730 function can be used to apply the L2 loss to the pretrained T2V diffusion model to adjust the pretrained T2V diffusion model. The adjustment, e.g., training, can take the form of including LoRA rules in the diffusion model to represent the target motion features, such as in a motion learning LoRA function 740. The LoRAs can be stored within the pretrained T2V diffusion model in a function 750. The pretrained T2V diffusion model is now further trained on the new target motions and can be used in other processes, such as to generate videos from a text prompt.

FIG. 8 is an illustration of a block diagram of an example video generation system 800. Video generation system 800 can receive a text prompt, a verbal prompt, a graphic prompt, or other types of prompts. Using the prompt, the trained T2V diffusion model (as trained, such as in FIG. 7), can generate a new video based on the prompt and the various sets of LoRAs stored within the trained T2V diffusion model, such as the target motions as derived from the reference video.

FIG. 9 is an illustration of a flow diagram of an example method 900 for adjusting the training for a pretrained T2V diffusion model. Method 900 can be performed on a computing system, for example, T2V system 1000 of FIG. 10 or T2V controller 1100 of FIG. 11. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 900 can be encapsulated in software code or hardware, for example, an application, code library, code module, dynamic link library, module, function, RAM, ROM module, and other software and hardware implementations. The software can be stored in a file, database, or other computing system storage mechanism. Method 900 can be partially implemented in software and partially in hardware. Method 900 can perform the steps for the described processes, for example, determining the target and diffusion feature motions and using the feature motions to update a set of LoRAs within a pretrained T2V diffusion model.

Method 900 starts at a step 905 and proceeds to a step 910. In step 910, input parameters can be received. The input parameters can include specified algorithms to use at each step of the process, for example, an algorithm to use to combine the M_{CA} and M_{TSA} attention maps. The algorithm can be additive or use other combining algorithms. The input parameters can specify various threshold parameters, such as a motion threshold parameter, where a movement has to exceed the threshold to be considered as a motion feature. This can, for example, remove vibration movement if that is not to be considered. Other thresholds can be a quality threshold parameter, such as to eliminate blurriness of an object, or other threshold parameters. The input parameters can include at least one reference motion video (e.g., target motion video). The input parameters can include operation parameters to direct the operation of the method or system.

In some aspects, the reference motion video can be sourced from a machine learning system. In some aspects, a text-to-video library of reference motion videos can be used. In some aspects, previously trained output videos can be used, along with the respective pretrained T2V diffusion models from a data store or library.

In some aspects, the input parameters can include a prompt used to guide the generation of the output video. In some aspects, the prompt can be reconstructed by replacing specific tokens with their respective superclasses, and the prompt can then be used to generate an appearance noise parameter and a motion noise parameter used by the spatial-temporal algorithms. The prompt can be a text prompt, an image prompt, a verbal or sound prompt, or other prompt types that can be received by the diffusion models.

In a step 915, target motion features can be extracted from the reference video (e.g., target motion video) using a neural network model. Diffusion motion features can be extracted from the pretrained T2V diffusion model. The extraction process can use, or be aided by a neural network model. The neural network model can be a deep learning neural network, a machine learning model, an artificial intelligence model, or other types of machine learning models.

In a step 920, motion features can be matched between the target motion features and the diffusion motion features using a feature matching objective function. The feature matching objective function utilizes a minimization of a Euclidean (L2) distance between the diffusion motion features and the target motion features, where the diffusion motion features are adjusted by the minimization function of the L2 distance. From the computed L2 loss, a set of LoRAs can be determined.

In a step 925, the pretrained T2V diffusion model can be adjusted using the set of LoRAs. This can allow the T2V diffusion model to more accurately replicate the target feature motions with whatever prompt is provided to the T2V diffusion model. In an optional step 930, a provided prompt can be input into the T2V diffusion model and used to generate a new video using the training and adjustments made to the T2V diffusion model. Method 900 ends at a step 995.

FIG. 10 is an illustration of a block diagram of an example T2V system 1000. T2V system 1000 can be implemented in one or more computing systems or one or more processors. In some aspects, T2V system 1000 can be implemented using a T2V controller such as T2V controller 1100 of FIG. 11. T2V system 1000 can implement one or more aspects of this disclosure, such as method 900 of FIG. 9.

T2V system 1000, or a portion thereof, can be implemented as an application, a code library, a dynamic link library, a function, a module, a header file, other software implementations, or combinations thereof. In some aspects, T2V system 1000 can be implemented in hardware, such as a ROM, a graphics processing unit, or other hardware implementations. In some aspects, T2V system 1000 can be implemented partially as a software application and partially as a hardware implementation. T2V system 1000 is a functional view of the disclosed processes, and an implementation can combine or separate the functions in one or more software or hardware systems.

T2V system 1000 includes a data transceiver 1010, a T2V diffusion processor 1020, and a result transceiver 1030. The output, e.g., the response to the text prompt, can be communicated to a data receiver as a result, such as to one or more of a processing system 1060 (one or more combinations of processors, or processing cores), one or more users or systems 1062, or one or more storage devices 1064 (such as a diffusion model library or database). The output can be used to present a response to a user, stored for future use, used as a T2V diffusion model for other prompts, or used as an input into other processing systems or machine learning systems. In some aspects, the output can be used by a video generator to generate an output video.

In some aspects, the results of T2V diffusion processor 1020, such as those communicated to one or more of processing system 1060, one or more storage devices 1064, or one or more users or systems 1062, can be used as input into another process or system, such as a machine learning system. The results can be used for further processing, such as input into artificial intelligence learning, for validation of other system processes, or real-world applications, such as producing a video using a prompt, such as a text prompt.

Data transceiver 1010 can receive the input parameters. The input parameters can include algorithms to use, various threshold parameters, and other operational parameters. The input parameters can include a prompt describing a video generation request. The input parameters can include at least one reference motion video (e.g., target motion video). In some aspects, data transceiver 1010 can be part of T2V diffusion processor 1020.

Result transceiver 1030 (e.g., a transmitter) can communicate one or more outputs (e.g., results), to one or more data receivers, such as one or more of processing system 1060, one or more users or systems 1062, storage devices 1064, or other related systems, whether proximate result transceiver 1030 or distant from result transceiver 1030. Data transceiver 1010, T2V diffusion processor 1020, and result transceiver 1030 can be, or can include, conventional interfaces configured for transmitting and receiving data. Data transceiver 1010, T2V diffusion processor 1020, or result transceiver 1030 can be implemented as software components, for example, a virtual processor environment, as hardware, for example, circuits of an integrated circuit, or combinations of software and hardware components and functionality. The functionality described for these components remains intact regardless of how the functionality is implemented.

T2V diffusion processor 1020 (e.g., one or more processors such as processor 1130 of FIG. 11) can implement the analysis and algorithms as described herein, utilizing the input parameters. T2V diffusion processor 1020 can execute code to implement an extraction of motion features, a matching of motion features between target motion features and diffusion motion features, a generation of the motion LoRAs to minimize the L2 distance (such as adjusting the diffusion motion features), execute code to implement other models and processes (such as a deep learning neural network), or various combinations thereof. T2V diffusion processor 1020 can be one or more of a multicore processor, a multiprocessor system, or a streaming multiprocessor. T2V diffusion processor 1020 can be implemented by a central processor unit (CPU), a graphics processor unit (GPU), or other types of processors. T2V diffusion processor 1020 can be a non-transitory computer program product having a series of operating instructions stored on a non-transitory computer-readable medium that directs a processing apparatus, when executed thereby to perform operations as disclosed herein.

A memory or data storage system of T2V diffusion processor 1020 (such as a core cache, L1 cache, L2 cache, or other memory systems) can be configured to store the processes and algorithms for directing the operation of T2V diffusion processor 1020. T2V diffusion processor 1020 can include a processor that can be configured to operate according to the analysis operations and algorithms disclosed herein, and an interface to communicate (transmit and receive) data.

FIG. 11 is an illustration of a block diagram of an example of a T2V controller 1100 according to the principles of the disclosure. T2V controller 1100 can be stored on one computer or multiple computers. The various components of T2V controller 1100 can communicate via wireless or wired conventional connections. A portion or a whole of T2V controller 1100 can be located at one or more locations. In some aspects, T2V controller 1100 can be part of another system (e.g., a processor, a core, a server, or other systems), and can be integrated with one device, such as a part of a processing system. T2V controller 1100 represents a demonstration of the functionality employed for the disclosure, and implementations can use a variety of devices, for example, circuits of a processor, dedicated processors, virtual systems, servers, other computing or processing systems, in software or hardware, or various combinations thereof.

T2V controller 1100 can be configured to perform the various functions disclosed herein including receiving input parameters, prompts, pretrained T2V diffusion models, and reference motion videos (e.g., target motion videos), and generating results (e.g., an adjusted or further trained T2V diffusion model, generated video or prompt responses, or statuses) from the execution of the methods and processes described herein, such as extracting motion features, applying a feature matching objective, determining the motion LoRAs, and updating T2V diffusion models. T2V controller 1100 includes a communications interface 1110, a memory 1120, and a processor 1130.

Communications interface 1110 can be configured to transmit and receive data. For example, communications interface 1110 can receive the input parameters, including the prompts, the pretrained T2V diffusion models, and the reference videos. Communications interface 1110 can transmit the output or interim outputs. In some aspects, communications interface 1110 can transmit a status, such as a success or failure indicator of T2V controller 1100 regarding receiving the various inputs, transmitting the generated outputs, or producing the results.

In some aspects, processor 1130 can perform the operations as described by T2V diffusion processor 1020. Communications interface 1110 can communicate via the communication systems used in the industry. For example, wireless or wired protocols can be used. Communication interface 1110 can perform the operations as described for data transceiver 1010 and result transceiver 1030 of FIG. 10.

Memory 1120 can be configured to store a series of operating instructions that direct the operation of processor 1130 when initiated, including supporting code representing the algorithms and processes described herein. Memory 1120 can be a non-transitory computer-readable medium. Multiple types of memory can be used for the data storage systems and memory 1120 can be distributed.

Processor 1130 can be one or more processors. Processor 1130 can be a combination of processor types, such as a CPU, a GPU, a single instruction multiple data (SIMD) processor, or other processor types. Processor 1130 can be configured to produce the output, one or more interim outputs, and statuses utilizing the received inputs. Processor 1130 can determine the output using parallel processing. Processor 1130 can be an integrated circuit. In some aspects, processor 1130, communications interface 1110, memory 1120, or various combinations thereof, can be an integrated circuit. Processor 1130 can be configured to direct the operation of T2V controller 1100. Processor 1130 includes the logic to communicate with communications interface 1110 and memory 1120, and perform the functions described herein. Processor 1130 can be capable of performing or directing the operations as described by T2V diffusion processor 1020 of FIG. 10.

For example, in some aspects, T2V system 1000 or T2V controller 1100 can perform as a subject learner configured to learn a set of token LoRAs representing the target motion features and update a T2V diffusion model with the LoRA. In some aspects, T2V system 1000 or T2V controller 1100 can be part of another system that receives the input parameters. For example, in some aspects, T2V system 1000 or T2V controller 1100 can be part of a machine learning system, an artificial intelligence (AI) generative tool, or can be in a data center, a cloud system, an edge system, a corporate system, or other type of system or location. In some aspects, T2V system 1000 or T2V controller 1100 can implement a video generator configured to use the adjusted pretrained T2V diffusion model to generate an output video using a text prompt, wherein an object specified in the text prompt follows the target motion features. In some aspects, T2V system 1000 or T2V controller 1100 can include an encoder configured to encode noisy videos using the diffusion motion features and spatio-temporal parameters encoded in attention maps of the pretrained T2V diffusion model, where the noisy videos can be utilized by the feature matching objective.

In some aspects, T2V system 1000 or T2V controller 1100 can be part of a machine learning system, where T2V diffusion processor 1020 can be part of the machine learning processes. In some aspects, T2V system 1000 or T2V controller 1100 can utilize the pretrained T2V diffusion model as the deep neural network to perform the described operations. In some aspects, T2V system 1000 or T2V controller 1100 can implement a non-transitory computer program product having a series of operating instructions stored on a non-transitory computer-readable medium that directs a data processing apparatus, when executed thereby to perform operations, the operations comprising the steps described herein for this disclosure, such as method 900 of FIG. 9.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for artificial intelligence (AI) computing and GPU data centers directed to AI computing. The HD GPU racks can be used with reactive machines, autonomous machines, self-aware machines, and self-learning machines that require a massive compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as those noted above are capable of delivering the performance required for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device, or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

Various aspects of the disclosure can be claimed including the apparatuses, systems, and methods as noted in the Summary. Each of the noted aspects can have one or more of the additional features of the below dependent claims in combination.

What is claimed is:

1. A text-to-video (T2V) system, comprising:
a receiver configured to receive a reference video and a pretrained T2V diffusion model, wherein the reference video includes target motion features;
a motion feature extractor configured to extract the target motion features from the reference video and diffusion motion features from the pretrained T2V diffusion model using a neural network model; and
a motion feature matcher configured to use a feature matching objective and to generate an adjusted pretrained T2V diffusion model from the pretrained T2V diffusion model by applying adjusted diffusion motion features, wherein the feature matching objective generates the adjusted diffusion motion features from the diffusion motion features by minimizing an L2 distance between the diffusion motion features and the target motion features.

2. The T2V system as recited in claim 1, further comprising:
a video generator configured to use the adjusted pretrained T2V diffusion model to generate an output video using a text prompt, wherein an object specified in the text prompt follows the target motion features.

3. The T2V system as recited in claim 1, wherein the target motion features include one or more of an orientation parameter, a movement parameter, a rotation parameter, a displacement parameter, or a zoom parameter.

4. The T2V system as recited in claim 1, wherein the neural network model is a deep neural network.

5. The T2V system as recited in claim 1, wherein the feature matching objective uses spatio-temporal relationships of objects within the reference video and of the objects within the pretrained T2V diffusion model.

6. The T2V system as recited in claim 1, wherein the motion feature extractor further comprises:
an encoder configured to encode noisy videos using the diffusion motion features and spatio-temporal parameters encoded in attention maps of the pretrained T2V diffusion model, and the noisy videos are utilized by the feature matching objective.

7. The T2V system as recited in claim 6, wherein the attention maps include one or more of cross-attention maps (CA) that include coarse-grained motion trajectories or temporal self-attention maps (TSA) that include fine-grained motion dynamics.

8. The T2V system as recited in claim 1, wherein low-rank adaptations of the pretrained T2V diffusion model are adjusted with the adjusted diffusion motion features.

9. The T2V system as recited in claim 1, wherein the L2 distance is determined using a Chamfer algorithm.

10. A system, comprising:
a receiver configured to receive input parameters, wherein the input parameters include at least a pretrained text-to-video (T2V) diffusion model, at least one target motion video, and operation parameters; and
one or more processors, configured to execute code to generate an adjusted pretrained T2V diffusion model from a received pretrained T2V diffusion model by extracting target motion features from the at least one target motion video, extracting diffusion motion features from the received pretrained T2V diffusion model, and using a feature matching objective to adjust the received pretrained T2V diffusion model by minimizing an L2 distance between the diffusion motion features and the target motion features.

11. The system as recited in claim 10, wherein the one or more processors extracts the diffusion motion features by using the pretrained T2V diffusion model to extract spatial-temporal motion trajectories and inter-frame motion dynamics.

12. The system as recited in claim 11, wherein the one or more processors uses cross-attention maps and temporal self-attention maps from the pretrained T2V diffusion model to extract the spatial-temporal motion trajectories and the inter-frame motion dynamics.

13. The system as recited in claim 10, further comprising:
a transmitter configured to communicate the adjusted pretrained T2V diffusion model to another system or a data store.

14. The system as recited in claim 10, further comprising:
a video generator configured to use the adjusted pretrained T2V diffusion model to generate an output video using a text prompt, wherein an object specified in the text prompt follows the target motion features.

15. The system as recited in claim 10, wherein the one or more processors are further configured to encode noisy videos using the diffusion motion features, motion trajectories of objects of the diffusion motion features, and motion dynamics of the objects of the diffusion motion features, and the feature matching objective utilizes the noisy videos.

16. The system as recited in claim 10, wherein the one or more processors utilize a deep neural network.

17. The system as recited in claim 10, wherein the one or more processors is one or more of a central processor unit (CPU) or a graphics processor unit (GPU).

18. A method, comprising:
receiving a reference video and a pretrained text-to-video (T2V) diffusion model, wherein the reference video includes target motion features;
extracting the target motion features from the reference video using a neural network model;
extracting diffusion motion features from the pretrained T2V diffusion model using the neural network model;
matching motion of the diffusion motion features to the target motion features using a feature matching objective, wherein the feature matching objective utilizes a minimization of an L2 distance between the diffusion motion features and the target motion features; and
generating an adjusted pretrained T2V diffusion model by applying an output of the feature matching objective to the pretrained T2V diffusion model.

19. The method as recited in claim 18, further comprising:
storing the adjusted pretrained T2V diffusion model in a library to be utilized as a video generator.

20. The method as recited in claim 18, further comprising:
receiving a text prompt describing an object and a motion for the object; and
generating an output video using the adjusted pretrained T2V diffusion model and the text prompt.

21. A non-transitory computer-readable medium having a series of operating instructions stored thereon that directs a data processing apparatus when executed thereby to perform operations, the operations comprising:
receiving a reference video and a pretrained text-to-video (T2V) diffusion model, wherein the reference video includes target motion features;
extracting the target motion features from the reference video using a neural network model;
extracting diffusion motion features from the pretrained T2V diffusion model using the neural network model;
matching motion of the diffusion motion features to the target motion features using a feature matching objective, wherein the feature matching objective utilizes a minimization of an L2 distance between the diffusion motion features and the target motion features; and
generating an adjusted pretrained T2V diffusion model by applying an output of the feature matching objective to the pretrained T2V diffusion model.

22. The non-transitory computer-readable medium as recited in claim 21, wherein the pretrained T2V diffusion model is a deep neural network and the operations are performed by the pretrained T2V diffusion model.
